(19) United States
(12) Patent Application Publication
(10) Pub. No.: US 2014/0244335 A1
(43) Pub. Date: Aug. 28, 2014

(54) TECHNIQUES FOR DERIVING A SOCIAL PROXIMITY SCORE FOR USE IN ALLOCATING RESOURCES

(71) Applicant: Linkedin Corporation, Mountain View, CA (US)

(72) Inventors: Tyler Baldwin, Santa Clara, CA (US); Chen Chang, San Jose, CA (US); Joshua Richard VanGeest, Sunnyvale, CA (US); Mike Derezin, Alamo, CA (US)

(73) Assignee: LINKEDIN CORPORATION, MOUNTAIN VIEW, CA (US)

(21) Appl. No.: 13/781,408

(22) Filed: Feb. 28, 2013

(51) Int. Cl. G06Q 10/06; G06Q 50/00

(52) U.S. Cl. CPC G06Q 10/063118; G06Q 50/01
USPC 705/7.17

(57) ABSTRACT

Techniques for analyzing a social graph of a social networking service to derive a social proximity score representing a measure of how socially connected a member is to a target entity are described. With some embodiments, for each member of the social networking service in a pre-defined group of members, a social proximity score is derived to reflect a measure of how socially connected the member is to a target entity (e.g., company, school, government institution, or some other organization). The social proximity score for each member-target entity pairing may be based on a variety of factors derived from analyzing the social graph, member profile information, and in some instances, the activity and behavior of the members.

### TECHNICAL FIELD

The present disclosure generally relates to data processing systems. More specifically, the present disclosure relates to methods, systems and computer program products for use in analyzing a social graph of a social networking service for the purpose of deriving, for each member in a group of members, a social proximity score representing a measure of how socially connected an individual member is to a particular entity or organization.

### BACKGROUND

The success of any business organization depends largely on the effectiveness of the organization's sales team. A business organization with excellent manufacturing operations, cutting-edge technology, tight financial goals, and progressive management techniques will still struggle if it lacks an effective sales mechanism. At least one aspect that impacts the overall effectiveness of a sales team is the manner in which sales resources—that is, the individual members of the sales team (commonly referred to as sales representatives)—are allocated or assigned to the various customer accounts of the business organization. Conventional thinking regarding the allocation of sales resources typically focusses on one or more market segmentation techniques. For example, as illustrated in FIG. 1, many business organizations segment a target market into different geographical regions, and then allocate sales representatives to manage customer accounts based on the geographical region of the customer and the sales representatives. While such a technique may prove more effective than randomly allocating customer accounts to sales representatives, more effective techniques for allocating sales resources are desirable.

### DESCRIPTION OF THE DRAWINGS

Some embodiments are illustrated by way of example and not limitation in the FIGS. of the accompanying drawings, in which:

FIG. 1 is a diagram illustrating a conventional technique for allocating resources based on a geographical segmentation of a market;

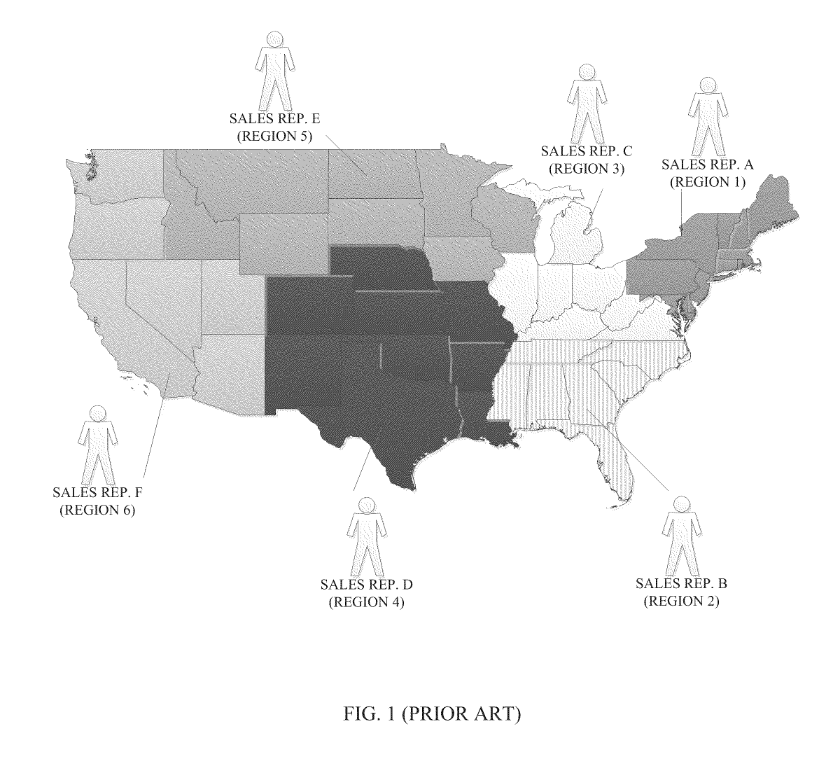

FIG. 2 is a block diagram showing the functional components of a social networking service, including a data processing module referred to herein as a social proximity score-generating module for use in deriving a social proximity score representing a measure of how socially connected a member is to an entity (e.g., a company), consistent with some embodiments of the invention;

FIG. 3 is a block diagram illustrating an example of a portion of a graph data structure for modelling a social graph, according to some embodiments of the invention;

FIG. 4 is a flow diagram illustrating the method operations involved in a method for computing or deriving a social proximity score, consistent with some embodiments of the invention;

FIG. 5 is a diagram showing an abstract representation of a target entity (e.g., a company) with employees being members of a social networking service and being segmented by certain predefined criteria (e.g., job titles, job functions, seniority), consistent with some embodiments of the invention;

FIG. 6 is a table illustrating an example of the output data provided by a social proximity score generating module, consistent with some embodiments of the invention;

FIG. 7 is a block diagram illustrating an example of the inputs and outputs of a resource allocation module, consistent with some embodiments of the invention;

FIG. 8 is a user interface diagram illustrating an example of the output of a resource allocation module, consistent with some embodiments of the invention; and

FIG. 9 is a block diagram of a machine in the form of a computing device within which a set of instructions, for causing the machine to perform any one or more of the methodologies discussed herein, may be executed.

### DETAILED DESCRIPTION

The present disclosure describes methods, systems and computer program products for use in analyzing a social graph of a social networking service for the purpose of deriving a metric referred to herein as a social proximity score. In the context of the present disclosure, a social proximity score is a score (e.g., a number) that represents a measure of how socially connected an individual is to another entity represented in the social graph—such as a company, educational institution, government entity or organization, non-profit organization, or any other type of organization. By deriving social proximity scores for two or more people, the degree to which each person is connected or related to a particular target entity (e.g., a company) can be compared, thereby improving resource allocation decisions and techniques.

For example, consider a situation in which a business organization is assigning a particular customer account to a sales representative of a sales team. The social proximity scores of the individual sales representatives can be compared with one another, such that the customer account is ultimately assigned to a sales representative that has a social proximity score that is generally higher than that of his or her peers, indicating a greater level of connectedness between the sales representative and the company representing the customer account. In the following description, for purposes of explanation, numerous specific details are set forth in order to provide a thorough understanding of the various aspects of different embodiments of the present invention. It will be evident, however, to one skilled in the art, that the present invention may be practiced without all of the specific details and/or with variations, permutations and combinations of the various features and elements described herein.

As described in greater detail below, with some embodiments, for each member of a social networking service in a particular group of members (e.g., each sales representative for a particular business organization) and a particular target entity (e.g., a customer account of the business organization), asocial proximity score is derived based on analysis of the social graph maintained by the social networking service, and in some instances, analysis of the individual member profiles of members who are connected via the social graph. In addition, with some embodiments, the interactions that individual members of the social networking service have with one another may be tracked and used in deriving social proximity scores.

In various embodiments a social proximity score may be derived based on various factors, including but not limited to any one or more of the following: the number of connections that a member has with other members employed with the target entity, the number of connections of a particular type or degree (e.g., first-degree connections, second-degree connections, etc.) that the member has with other members employed with the target entity, the number of connections that the member has with other members employed with the target entity who satisfy certain criteria (e.g., key decision makers, as indicated by member profile attributes, social graph information, or activity/behavioral data). With some embodiments, a social proximity score may be based on some weighted combination of the above factors. For example, in deriving a social proximity score, the number of first-degree connections may be weighted with a weighting factor to contribute more to the overall social proximity score than second-degree connections. Similarly, connections to members employed with the target entity and satisfying certain criteria (e.g., job function, job title, seniority level, etc.) may be weighted more heavily than connections to members employed with the target entity, but not satisfying the criteria.

With some embodiments, a social proximity score reflects not only the number of connections, or the number of connections of a particular type, or which satisfy some criteria, but also the strength of individual connections. For example, as described in greater detail below, in some instances the social graph maintained by the social networking service will reflect the strength of a connection path connecting any two nodes (e.g., members) in the social graph. With some embodiments, the connection strength of a connection path connecting two members may be used as a weighting factor when deriving the social proximity score for a particular member and target entity pair. In general, the connection strength of a connection path connecting two members may be based on a variety of factors including factors derived from analysis of various member profile attributes, social graph information, as well as activity or behavioral data.

Consistent with some embodiments of the present invention, a software application or service includes functionality that facilitates and supports the resource allocation decision-making process—that is, the process by which resources and particularly human resources e.g., sales representatives, recruiters, marketing specialists) are allocated or assigned to existing customer accounts, new customer accounts, customer leads, and so forth. Accordingly, the software application or service includes a score-generating module that receives as input some information identifying a member of a social networking service and some information identifying a target entity (e.g., a company). Using these two inputs, the score-generating module analyzes a variety of social graph and member profile information, and computes or derives a social proximity score representing a measure of how socially connected the member is to the particular target entity. With some embodiments, this process is repeated for any number of members of a defined group, for example, such as a set of sales representatives on a sales team. The process may also be repeated for any number of target entities. Once the social proximity scores are determined for each member of the team, and for any number of target entities, the scores may be used as one of any number of inputs to a process or tool that facilitates and/or supports the resource allocation decision-making process. For example, for a particular target entity, a group of sales representatives may be displayed in order of their corresponding social proximity scores, such that the sales representative who has the highest social proximity score and is the most socially connected to the target entity, appears at or near the top of a list. Additional user interface elements may allow for an administrator to quickly and easily make resource allocation decisions, for example, by simply selecting or interacting with user interface elements (e.g., buttons, drop-down lists, links, etc.) to memorialize resource allocation decisions.

As described in greater detail below, with some embodiments, the social proximity score for a particular member and target entity pairing is derived as a function of the number of connections that the particular member has to other members of the social networking service who, based on their respective member profile information, have indicated they are employed with the target entity. Accordingly, with some embodiments, one of the operations performed is a query to identify the set of all members of the social networking service who, according to the social graph or information in their respective member profiles, are currently employed with the target entity. Next, analysis of the social graph is performed to identify all of the connections that the particular member has with other members in the set of members of the social networking service who are currently employed with the target entity. In various alternative embodiments, only connections of a certain degree are considered and will contribute to the social proximity score. For example, in some instances, only first-degree or direct connections will contribute to the social proximity score. Similarly, in some instances, first and second-degree connections will contribute to the social proximity score, where a second-degree connection is a connection that involves one intermediate node (e.g., a friend-of-a-friend). In those instances in which both first and second-degree connections contribute to the overall social proximity score, one or more weighting factors may be used to increase the contribution of first-degree connections to the overall social proximity score, relative to the contribution of second-degree connections. This may be done to reflect the fact that first-degree or direct connections typically are more highly valued because they reflect a greater level of social connectedness than second-degree connections.

Just first-degree and second-degree connections may not contribute equally to the social proximity score, with some embodiments not all connections of the same degree (e.g., all first-degree connections) contribute equally to the social proximity score. For example, if the particular member for whom the social proximity score is being derived is connected to a member of the social networking service who is employed at the target entity in a decision-making capacity, the connection may be of greater importance than a first-degree connection to another member employed in a different and less important capacity. Accordingly, with some embodiments, various weighting factors are applied to connections between the member and other members who have member profile information satisfying some predetermined criteria, or where the social graph information satisfies some predetermined criteria.

For instance, consider a scenario in which a sales representative of a computer supply company is being allocated or assigned to a new customer account (e.g., the target entity). If the sales representative is connected via the social graph of the social networking service to one or more members of the social networking service who have member profile information indicating employment with the target entity in a particular rote (e.g., Director of Information Technology, Information Technology Manager, Purchasing Manager, etc.), a weighting factor may be applied to that connection or those connections to reflect their relatively greater value in terms of their significance in representing social connectedness than first-degree connections to other members employed with the target entity in positions not relevant to making information technology purchasing decisions. With some embodiments, the weighting factors that are applied to certain connections between the particular member and the employee-member of the target entity are dependent upon members having specified particular job titles, and/or job functions in their respective member profiles. Additionally, or alternatively, member profile information indicating a member's seniority level may be taken into consideration, such that connections with members who satisfy some seniority requirement are weighted to reflect a greater significance in representing social connectedness. Of course, with some embodiments, member profile characteristics other than job title, job function and seniority level may be considered and associated with different weighting factors. In some instances, a connection to a particular person (e.g., the Chief Executive Officer, the Director of Sales, the General Counsel) may be deemed important, such that the criteria may not be a job title, but the actual name of the person. With some embodiments, different weighting factors may be associated with different sets of criteria, such that a connection with a member of the social networking service who has member profile information satisfying a first set of criteria will have a first weighting factor applied, and a connection with a member having member profile information satisfying a second set of criteria will have a second weighting factor applied. As such, certain categories of connections meeting different criteria may be afforded a different weighting factor to reflect their relative importance in computing the social proximity score for a particular member and target entity pairing.

Because certain connections to members employed at the target entity (e.g., company) may be deemed more important or valuable than others, when certain criteria are met some connections may have a weighting factor applied to increase their overall influence or impact on the social proximity score. For example, if a particular member (e.g., a sales representative) is connected to a member of the social networking service who is employed at the target entity, and the two members share a certain threshold number of connections in common, a weighting factor may be applied. Similarly, if the two members previously worked at the same company, either at different times or at the same time, a weighting factor may be applied to the connection to increase its contribution to the overall social proximity score. Weighting factors may also be applied when the two connected members share in common certain member profile attributes (e.g., job title, geographic location of employment or residence, etc.), share in common a certain number or set of skills, and/or graduated or attended the same school.

With some embodiments, one or more operations may be performed to normalize the social proximity scores, for example, to account for variations in the size (e.g., number of employees) of different companies. This makes comparison of social proximity scores for different target entities (e.g. companies) more meaningful. For example, a very large company may have hundreds of senior level people with a common job title (e.g., Vice President of Sales), whereas a small company may have only one employee with such a title. If a business organization has a sales representative that is connected via the social networking service to the one and only employee of the small company with the title, Vice President of Sales, this is a much more meaningful data signal than having a sales representative with a connection to one employee of the hundreds of employees of a large company with the same title, Vice President of Sales. Accordingly, with some embodiments, when deriving the social proximity score, the number of connections to members having member profile information satisfying some criteria may be divided by the total number of members employed at the target entity who have member profile information satisfying that criteria. As such, a connection to the one and only employee of a target company having member profile information satisfying some predefined criteria (e.g., job title =“V.P. of Sales”) will contribute more toward a social proximity score than will a single connection to a member satisfying the same criteria, when there are multiple employees having member profile information satisfying that criteria.

With some embodiments, the total number of connections (particularly second-degree connections) that a member may have with other members employed at a target entity may be extremely high. Accordingly, with some embodiments, a logarithmic scale is used to deemphasize the relative impact that each additional connection may have to the social proximity score, particularly when there are a large number of connections. When the number of connections is being normalized to account for the total possible number of connections, the logarithm operation is applied to both the numerator (representing the number of connections of a particular type that a member has with a target entity) and the denominator (representing the total number of possible connections of that particular type).

With some embodiments, an administrative user interface enables an administrator with appropriate privileges to configure various parameters and settings that affect the algorithm or process by which a social proximity score is computed or derived. In particular, an administrator-specified parameter or setting may define the particular type or degree of connections (e.g., first degree, second degree, third degree, and so forth) that are considered in deriving the social proximity score. In addition, an administrator may specify various parameters or settings for the weighting factors that are applied to different connection degrees (e.g., first-degree connections vs. second-degree connections) as well as connections with members having member profile information satisfying certain administrator-specified criteria (e.g., certain job titles, job functions, seniority levels, etc.). Additionally, with some embodiments, the administrative interface enables an administrator to specify various criteria (e.g., member profile attributes, social graph information, or activity/behavioural data) and corresponding weighting factors, such that, when deriving a social proximity score, a connection with a member having member profile information satisfying the administrator-specified criteria will be weighted in accordance with the corresponding administrator-specified weighting factor. In this way, the administrator can specify the member profile characteristics (e.g., job titles, job functions, seniority levels, and so forth) that are deemed important in the particular context for which the social proximity scores are being derived. With some embodiments, in addition to specifying criteria involving certain member profile attributes, an administrator may specify that weighting factors are to be applied to connections where certain criteria relating to the social graph are satisfied for example, where the two connected members share a certain threshold number of mutual connections. Similarly, weighting factors may be applied to those connections for which two members are actively engaged with one another, as evidenced by activity or behavioral data.

By providing the flexibility to dynamically configure the manner in which the social proximity scores are derived, the social proximity scores can be used to support a variety of different decision making processes. For example, if the social proximity scores are being generated with a view to allocating sales representatives to customer accounts, an administrator can specify that connections to employees of the target entity employed in senior sales-related decision making positions are to be weighted more heavily than connections with other members who are less senior and/or employed in non-sales-related roles. Specifically, by mapping different weighting factors to different sets of criteria (e.g., different job titles, job functions and seniority levels), an administrator can tailor the algorithm for computing social proximity scores to suit a particular decision making process. Other advantages and aspects of the several embodiments of the present invention will be readily apparent from the description of the figures that follows.

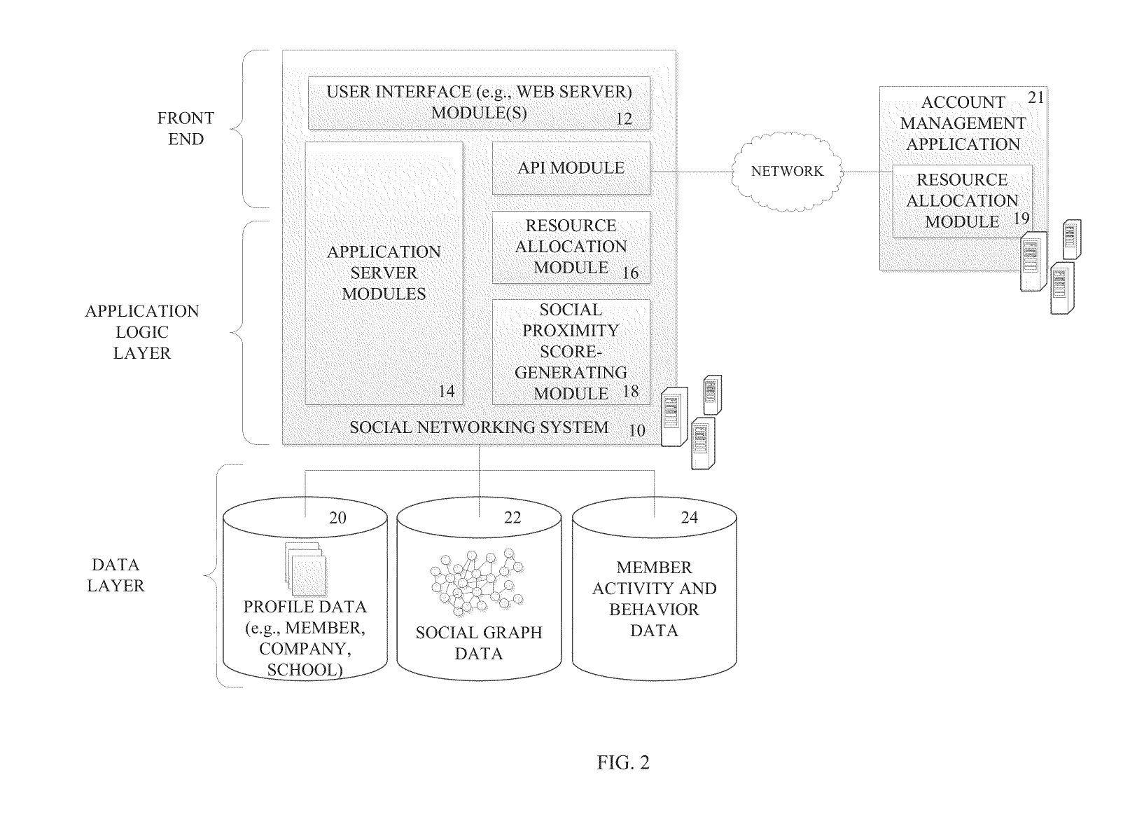

FIG. 2 is a block diagram showing the functional components of a social networking service, including a data processing module referred to herein as a social proximity score-generating module 18 (or, simply score-generating module), for use in computing or deriving social proximity scores. As shown in FIG. 2, the front end consists of a user interface module (e.g., a web server) 12, which receives requests from various client-computing devices, and communicates appropriate responses to the requesting client devices. For example, the user interface module(s) 12 may receive requests in the form of Hypertext Transport Protocol (HTTP) requests, or other web-based, application programming interface (API) requests. The application logic layer includes various application server modules 14, which, in conjunction with the user interface module(s) 12, generates various user interfaces (e.g., web pages) with data retrieved from various data sources in the data layer.

As shown in FIG. 2, the data layer includes several databases, such as a database 20 for storing profile data, including both member profile data as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database with reference number 20. With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require a bi-lateral agreement by the members, such that both members acknowledge the establishment of the connection. Similarly, with some embodiments, a member may elect to “follow” another member. In contrast to establishing a connection, the concept of following another member typically is a unilateral operation, and at least with some embodiments, does not require acknowledgement or approval by the member that is being followed. The various associations and relationships that the members establish with other members, or with other entities and objects, are stored and maintained within the social graph, shown in FIG, 2 with reference number 22.

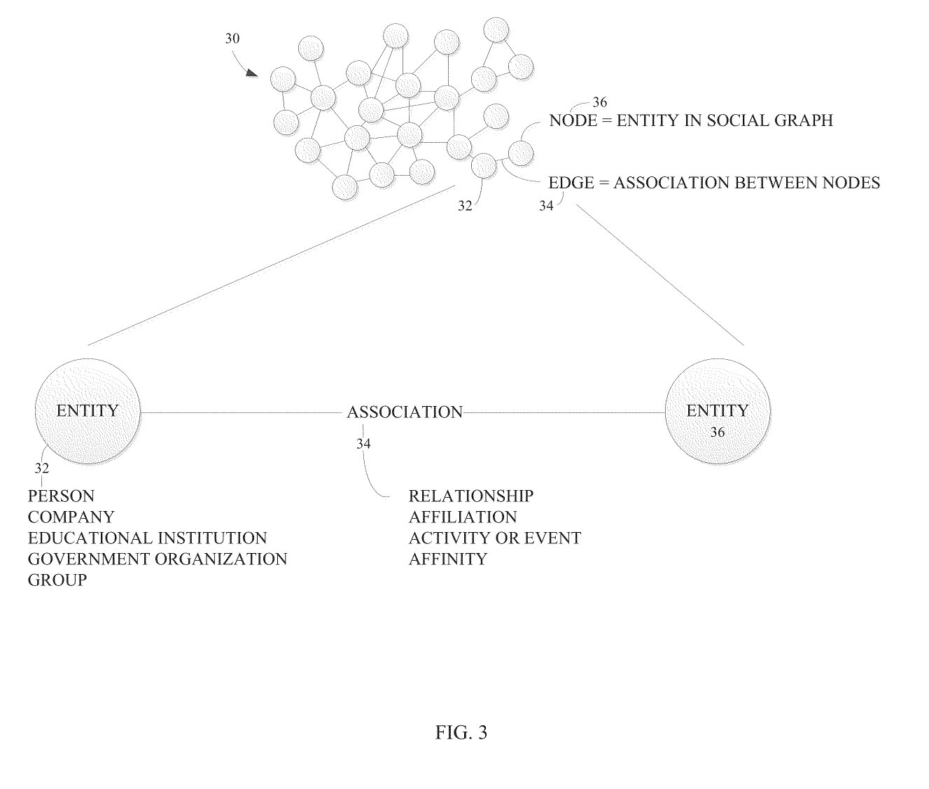

An example of a portion of a data structure 30 for modelling a social graph is shown in FIG. 3. As illustrated in FIG. 3, the graph data structure 30 consists of nodes connected by edges. For instance, the node with reference number 32 is connected to the node with reference number 36 by means of the edge with reference number 34. Each node in the graph data structure 30 represents an entity in the social graph. With some embodiments, any number of entity types may be included in the social graph. For example, as illustrated in FIG. 3, the entity types that exist in one implementation of a social graph, consistent with some embodiments of the invention, are: a person, a company, an educational institution (e.g., college, school or university), a government organization or entity, and a group (e.g., an online group, hosted by the social networking service, or some other third party server system, or a real-world organization, such as a professional organization.) The edges that connect any two nodes can represent a wide variety of different associations. For example, in general, an edge may represent a particular type of relationship, a particular affiliation, attendance at an activity or event, or some other affinity shared in common between two entities. For example, an edge connecting two nodes that represent people may be representative of a specific type of relationship between the two people, including a direct, bilateral connection between the two people. Similarly, in the case of a directed graph, an edge between two nodes representing people may indicate a “following” relationship, where one person has unilaterally subscribed to receive information about, or relating to, the other person. An edge connecting a first node, representing a person, with a second node, representing a company, may be representative of an employment relationship (current or previous) between the person and the company. Similarly, an edge connecting a first node, representing a person, with a second node, representing an educational institution, may represent or indicate that the person matriculated with or graduated from a particular school or university. Of course the list of associations 34 shown in FIG. 3 is by no means exhaustive, and any number of other association types may be mapped to the edges of a social graph data structure to indicate the association between entities in a social graph of a social networking service.

In addition to the edges having a particular type, representative of the nature of the relationship between two entities, each edge connecting two entities may be assigned an edge score to reflect the strength, or relevance, of the particular association or relationship that exists between the entities represented by the nodes. With some embodiments, the particular type of association or relationship represented by the edge may determine the edge score assigned to each edge. For example, if an edge represents a bi-lateral direct connection between two people, the score assigned to the edge may be higher than if the edge represents a “following” relationship, where one person has unilaterally taken action to “follow” another person. With some embodiments, the scores assigned to various edges may be algorithmically determined based on a wide variety of factors, including analysis of the social graph, member profile information, as well as various member activities and behaviors. For example, an edge score for an edge connecting two members of the social networking service may be based in part on the number of member profile attributes that the two members share in common. Similarly, an edge score for an edge connecting two members of the social networking service may be based in part on the two members sharing in common specific member profile attributes. Accordingly, the edge score for an edge connecting two members residing in the same geographical location, as indicated on their respective member profiles, may be higher than an edge score assigned to two connected members who live in different geographical locations. Similarly, an edge score for an edge connecting two members may be derived in part based on the number of mutual connections shared between the two members. In yet another example, an edge score may be algorithmically determined based in part on analysis of member activity and behavior data, including the frequency and recency of certain interactions between the members. For instance, if two members of the social networking service are directly connected with one another, and the two members frequently interact with one another, for example, by exchanging emails, exchanging messages (e.g., instant messages, text messages, etc.), conversing by telephone, sharing content, commenting on content items posted to a content stream or activity or content feed, and so forth, the edge score assigned to the edge connecting the two members in the social graph may be determined at least in part on the level (e.g., amount) of activity, as well as the timing (e.g., recency) of the activity, with more recent activity contributing more to the edge score. A time decay algorithm may be used to weight the contribution toward the edge score of an activity, based on when the activity occurred, such that activities occurring in the distant past influence the connection strength score less than recent activities.

Referring again to FIG. 2, the social networking service may provide a broad range of applications and services that allow members the opportunity to share and receive information, often customized or personalized to the interests of the member. As members interact with the various applications, services and content made available via the social networking service, the members' behavior (e.g., content viewed, links or buttons selected, messages responded to, etc.) may be tracked and information concerning the member's activities and behavior may be logged or stored, for example, as indicated in FIG. 2 by the database with reference number 24. This information may be used, for example, to determine the connection strength between members.

As illustrated in FIG. 2, the social networking system 10 includes what is referred to as a resource allocation module 16. The resource allocation module facilitates the allocation of resources (e.g., human resources, such as sales representatives) to various target entities, such as companies and other organizations, For instance, given a set of rule-based constraints, the resource allocation module 16 attempts to identify the most suitable person that is, the person with the highest social proximity score—to be assigned to each of the target entities (e.g., customer account) while also satisfying all of the rule-based constraints. Accordingly, the resource allocation module 16 will request from the social proximity score-generating module 18 a set of social proximity scores for various member and target entity pairings. Upon receiving the set of social proximity scores for various member and target entity pairings, the resource allocation module 16 may automatically identify the best mapping of resources to target entities, such that all rule-based constraints are satisfied, and the persons with the highest social proximity scores are assigned to the target entities.

As illustrated in FIG. 2, with some embodiments, the resource allocation module 16 is integrated with the social networking system 10. When integrated with the social network system 10, users will generally access the resource allocation module via a client application (not shown) executing and residing on a client computing device. The client application may be a web browser-based application, or some other proprietary client application.

With some embodiments, the social proximity score-generating module 18 may be accessible to one or more resource allocation modules 17 that reside and execute on a computing device of a third-party—that is, some entity other than the entity that operates the social networking service. Accordingly, at least with some embodiments, the functionality of the social proximity score-generating module 18 may be made available via an application programming interface (API) module 19, such that third-party applications can request and receive social proximity scores over a network. For example, using an API, an application, such as an account management application 21, may be able to request the social proximity scores for particular members or set of members, identified by respective member identifiers.

With some embodiments, the resource allocation module uses one or more algorithms for automatically making resource allocation recommendations and/or decisions. For example, the resource allocation module (16 or 19) may initially allow a user e.g., an administrator) to identify those members of the social network service who are also part of a team or group such as all sales representatives for a particular business organization. In addition, the resource allocation module may allow a user to select or otherwise identify any number of target entities (e.g., companies, educational institutions, government organizations, and so forth). The target entities may represent existing customer accounts of the business organization, new accounts that are being targeted for business development, and on forth. The entities may be identified by some identifying information (e.g., a Dunn and Bradstreet company identifier) or selected based on a query indicating desired company attributes (e.g., size, industry, location, etc.). In any case, the resource allocation module 16 may use any number of optimization algorithms to map individuals (e.g., sales representatives) to target entities, where at least one mechanism by which resource allocation decisions are made is a social proximity score representing a measure of how socially connected a member is to a target entity. Accordingly, with some embodiments, the resource allocation module 16 may request that the social proximity score-generating module 18 is to compute or derive social proximity scores for each member in the group of members (e.g., the group of sales representatives). This may be done for any number of target entities (e.g., customer accounts). Once the social proximity scores for all of the sales representatives have been generated for all target entities, an allocation optimization algorithm may be used to make resource allocation recommendations and/or decisions. For instance, for each target entity, a list of the members meeting all of the specified criteria and having the highest social proximity scores may be presented.

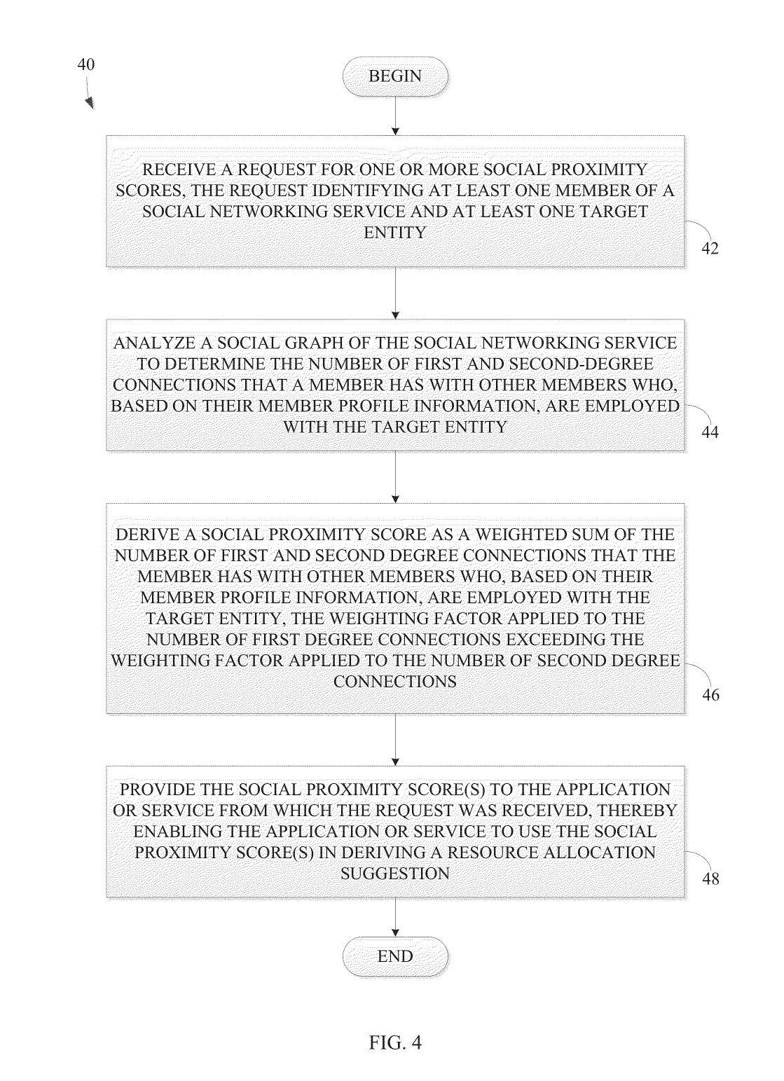

FIG. 4 is a flow diagram illustrating the various method operations that may be performed as part of a method for computing one or more social proximity scores, consistent with embodiments of the invention. The method begins at method operation 42 when the social proximity score-generating module receives a request for a set of social proximity scores, representing a measure of how socially connected a particular member is to a particular target entity. As such, the request may include information identifying the particular members and target entities for which the social proximity scores are being generated. With some embodiments, the request may include identifying information for each individual member and target entity, while in other embodiments, the members and target entities may be predefined and stored such that the request need only identify the pre-stored information.

At method operation 44, the score-generating module retrieves and analyzes a variety of social graph and member profile information to identify the connection paths between a member and any member that is employed with the target entity. In particular, with some embodiments, the connection paths of interest are first-degree connections, second-degree connections, and/or connections to members employed at the target entity in a particular capacity, as indicated by member profile information. The various connections may be tallied by their connection type or degree (e.g., first-degree connections, and second-degree connections) as well as connections that satisfy certain predefined criteria. For example, with some embodiments, when a member is connected to other members employed with the target, and those members have member profile information satisfying certain criteria (e.g., job title, job function, seniority level), those connections may be separately tallied. Furthermore, with some embodiments, each individual connection may be weighted to reflect a measure of the strength of the connection, as indicated by an edge score connecting two nodes in the social graph.

Next, at method operation 46, a social proximity score is computed or derived by combining the count of each category of connection, with one or more weighting factors applied to the count of connections for different categories. For example, first-degree connections may be weighted more heavily than second-degree connections. Similarly, connections with members satisfying certain criteria may be weighted to reflect the relative importance of such connections. The connection strength of each connection may be considered in determining the contribution of that connection, or type of connection, to the overall social proximity score. Finally, at method operation 48, the social proximity scores are provided to the application, service or functional module that initially made the request for the social proximity score or scores.

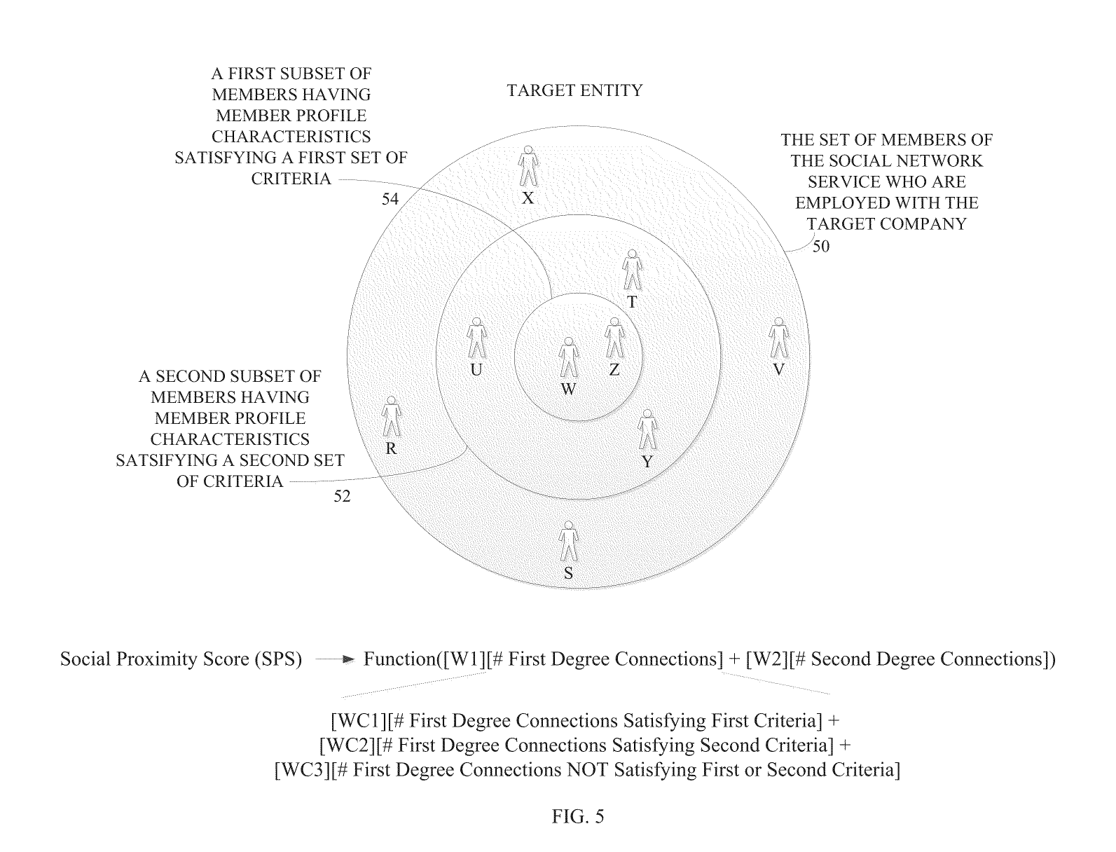

FIG. 5 is a diagram showing an abstract representation of a target entity (e.g., a company) with employees being members of a social networking service and being segmented by certain predefined criteria (e.g., job titles, job functions, seniority), consistent with some embodiments of the invention. For example, in the example of FIG. 5, the outermost circle with reference number 50 represents a set of members of a social networking service who, according to their member profiles, are currently employed with a target entity (e.g., a particular company). In this simplified example, this set of members includes members R, S, T, U, V, W, X, Y and Z.

The inner circle with reference number 52 represents a subset of the members defined by the circle with reference number 50. In particular, the subset of members represented by the inner circle with reference number 52 are those members of the social networking service who are both employed at the target entity and have member profile information that satisfies some predefined criteria. For example, the criteria may be that the member profiles of the members indicated a particular job title and job function. For instance, the subset of members defined by the inner circle with reference number 52 may be people who work at the target entity in a sales capacity, as indicated by a combination of their job title and job function. The subset of members satisfying the specified criteria includes members, T, U, W, Y and Z. These particular connections

The inner most circle, with reference number 54, represents a subset of all members of the social network service who are employed with the target entity. Specifically, the subset of members represented by the inner most circle includes members satisfying some second predefined criteria. Typically, these members will be key decision makers. For example, these members may be senior level employees working in a sales capacity, as indicated their member profiles. This subset includes members W and Z.

As indicated in the example formula with reference number 56, a social proximity score may be computed as the count of first-degree connections, weighted with a first weighting factor (W1), combined with a count of second-degree connections, weighted with a second weighting factor (W2). Of course, the second weighting factor, applicable to second degree connections, will typically be less than the weighting factor for first degree connections.

With some embodiments, the connections to members satisfying different criteria may be weighted accordingly, to reflect the importance of those connections relative to others. For example, the first degree connections that satisfy the first set of criteria (e.g., members U, T and Y) may be weighted with a weighting factor (WC1) to reflect there greater importance relative to others (e.g., R, S, V and X). Similarly, a connection to a member in the innermost circle—satisfying the second set of criteria—may be weighted in accordance with a second weighting factor (WC2) to indicate their greater importance. In this manner, a social proximity score for a member is computed.

With some embodiments, the total number of connections (particularly second-degree connections) that a member may have with other members employed at a target entity may be extremely high. Accordingly, with some embodiments, a logarithmic scale is used to deemphasize the relative impact that each additional connection may have to the social proximity score, when there are a large number of connections. Additionally, to normalize social proximity scores and provide for meaningful comparisons across target entities having different sizes (e.g., numbers of employees), with some embodiments the number of connections satisfying any particular criteria may be divided by the total possible number of members satisfying the criteria. In this way, the percentage of connection types is used as opposed to the absolute number of connections. Of course, in such a scenario the logarithm operation would be performed on both the numerator and denominator.

Although not shown in the simplified example of FIG. 5, with some embodiments, each individual connection may be weighted in accordance with a connection strength score that is algorithmically determined and maintained as part of the social graph of the social networking service. Accordingly, if a member frequently interacts with a member employed with the target entity, the connection strength score for the member may be higher, ultimately increasing the social proximity score for the particular member and target entity pairing.

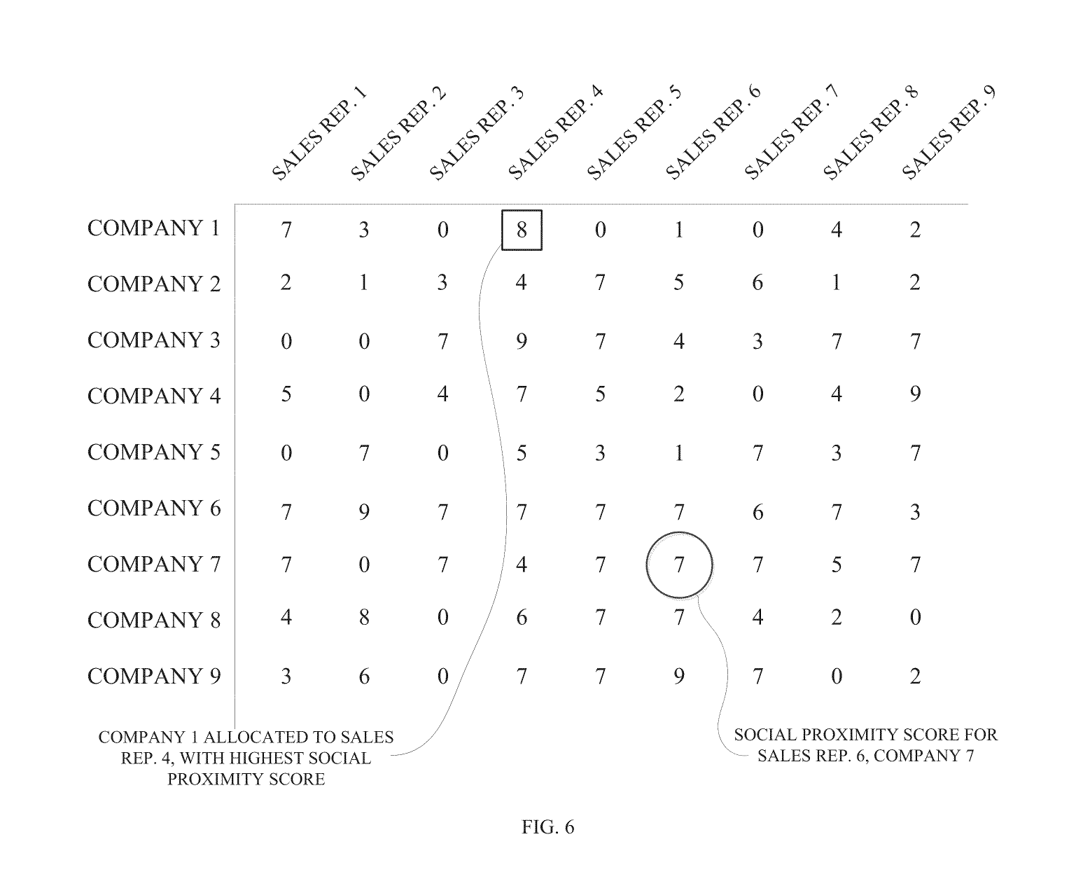

FIG. 6 is a table illustrating an example of the output data provided by a social proximity score-generating module, consistent with some embodiments of the invention. As illustrated in FIG. 6, with some embodiments, a social proximity score-generating module outputs a set of social proximity scores for each pairing of a member of the social networking service (e.g., a sales representative) and a company. As shown in this simplified example of FIG. 6, the social proximity scores are normalized to an integer number between one and ten. Of course, in various embodiments, different normalization techniques may result in scores covering different ranges.

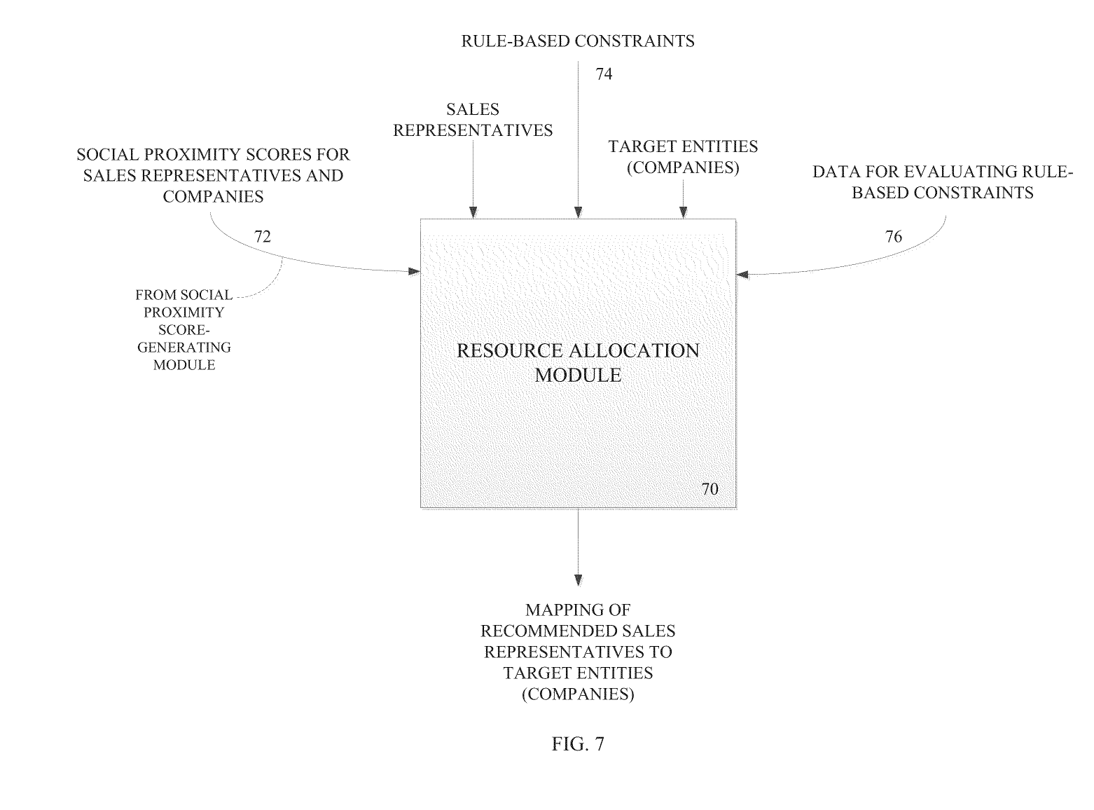

FIG. 7 is a block diagram illustrating an example of the inputs and outputs of a resource allocation module, consistent with some embodiments of the invention. As shown in FIG. 7, the resource allocation module 70 receives as input the output of the social proximity score-generating module (e.g., as shown in FIG, 6)—that is, the social proximity scores for a set of sales representatives and target entities. The social proximity scores may be retrieved from a database, accessed from a file, or obtained some other way. In addition, the resource allocation module 70 accesses a set of rule-based constraints 74, which may be configured by an administrator. Finally, the resource allocation module 70 receives as input a variety of data for use in evaluating the rules of the rule-based constraints.

While the number and nature of the particular rule-based constraints used in allocating resources will vary considerably and are highly implementation specific, some of the rule-based constraints include, but are certainly not limited to the following. One constraint involves one or more measures of revenue opportunity, sometimes referred to as the size of prize, or total addressable market. For example, when allocating a set of customer accounts to a particular sales representative, there may be a desired range of projected revenue that each sales representative is to be assigned and responsible for. Accordingly, this rule-based constraint may specify that the sum of all revenue opportunity from all accounts assigned to a particular sales representative should be no less than sonic lower threshold (a floor) and no higher than some higher threshold (a ceiling). Similarly, in some instances, the individual representatives may be assigned to different tiers or levels, such that the most experienced and efficient representatives are assigned to a highest tier, while the less experienced and less efficient representatives are assigned to a lower level or tier. Accordingly, one or more rules may dictate a minimum and maximum revenue opportunity for each tier or level, such that an account representing a particularly large revenue opportunity is not to be assigned to a sales representative who is in a lower tier or level, and similarly, an account representing a smaller revenue opportunity is not to be assigned to a sales representative in a higher tier or level. In some instances, a measure of the likelihood or probability of success for a particular account may also be taken into consideration. Accordingly, the revenue opportunity may be weighted based on the likelihood of realizing the revenue.

Other constraints may define a minimum number of accounts, a maximum number of accounts, or a range of accounts that are to be assigned to any one sales representative, or any one sales representative in a particular tier or level. Another constraint may be a geographical region. For example, in many instances, various members of a sales team will be assigned to different geographical regions. In allocating accounts to sales representatives, a rule-based constraint may dictate that a particular sales representative is only to be allocated accounts (e.g., target entities) in a particular geographical region.

Of course, with some embodiments, more complex rule-based constraints may be used. In particular, the rule-based constraints may provide for various exceptions—particularly, in situations where a sales representative has a social proximity score for a particular company or account that exceeds some threshold. For example, a rule may dictate that certain sales representatives are only to be allocated customer accounts within a given geographical region, unless their social proximity score for a particular customer account exceeds some threshold score. In some instances, various rule-based constraints may be defined to be applicable to all sales representatives, all representatives in a particular tier or level, all representatives within a particular geographical industry, or all representatives working with a particular internal business unit.

With a set of rule-based constraints defined, the resource allocation module 70 will allocate the target entities to the various sales representatives, such that the social proximity scores are maximized across all of the allocated representatives, while simultaneously ensuring that all rule-based constraints are satisfied. As such, the target entities (companies) are allocated to individual representatives, such that all rule-based constraints are satisfied, and the sales representatives with the highest social proximity scores for respective target entities are assigned to those entities.

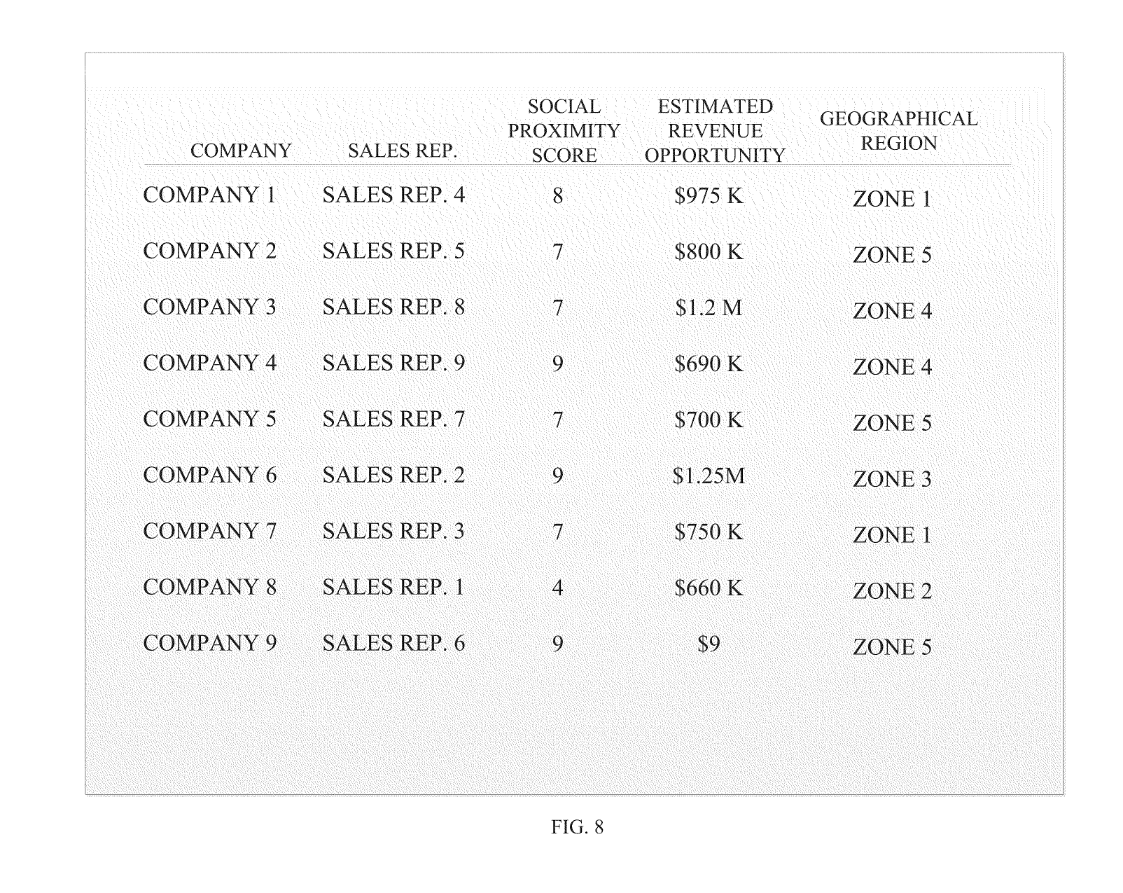

FIG. 8 is a table illustrating an example of the output of a resource allocation module, according to some embodiments. In this simplified example of FIG. 8, each company in a set of companies has been allocated to a corresponding sales representative. Of course, in many instances, each sales representative will be assigned or allocated to a large number of companies. Additionally, a wide variety of other information may be displayed with the mapping of company to sales representative.

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

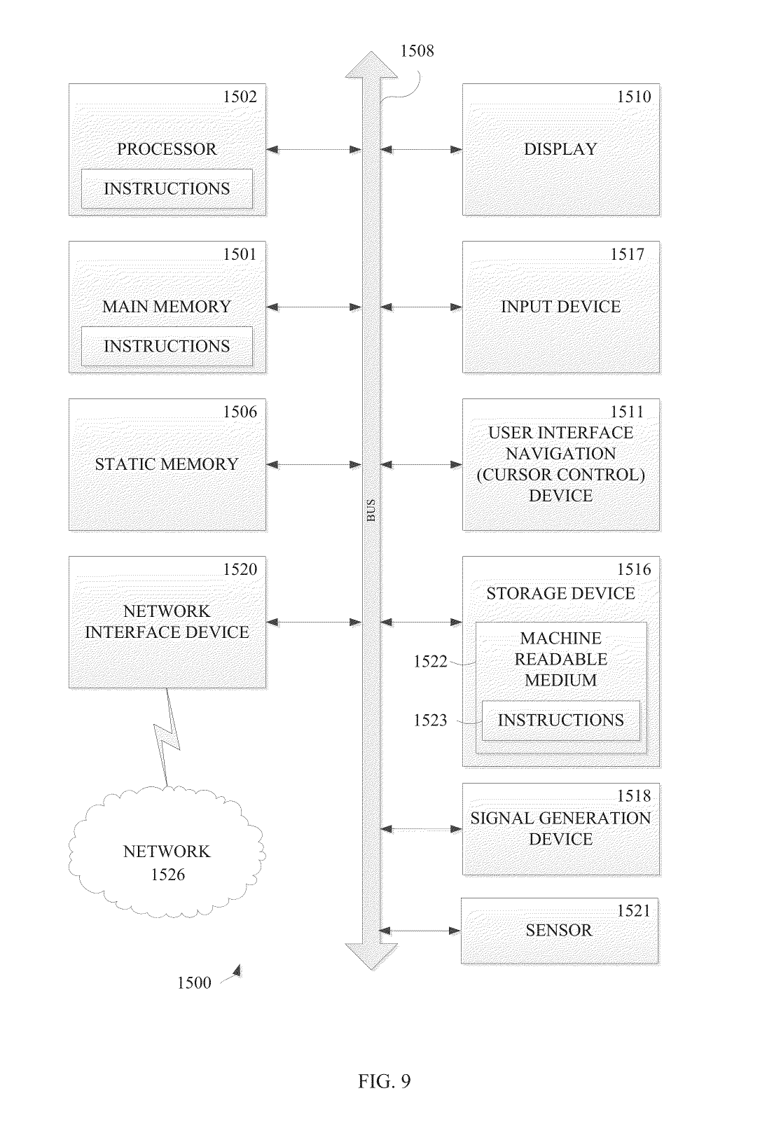

FIG. 9 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment, In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form apart hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to he taken in a limiting sense, and the scope of various embodiments is defined only by the appended claims, along with the full range of equivalents to which such claims are entitled.

What is claimed is:

1. A method comprising:
receiving a request to generate social proximity scores for each member and target entity pairing for a set of members of a social networking service and a set of target entities;
with a processor-implemented social proximity score-generating module, for each member and target entity pairing, deriving a social proximity score as a weighted combination of the number of first-degree and the number of second-degree connections that the member has with other members of the social networking service who have member profile information i) indicating current employment with the target entity and ii) satisfying some predefined criteria; and
storing the social proximity scores for each member and target entity pairing.

2. The method of claim 1, wherein the member profile information satisfying some predefined criteria includes member profile information indicating that a member having member profile information indicating current employment with the target entity has a job title matching any one of a plurality of predefined job titles.

3. The method of claim 1, wherein the member profile information satisfying some predefined criteria includes member profile information indicating that a member having member profile information indicating current employment with the target entity has a job function matching any one of a plurality of predefined job functions.

4. The method of claim 1, wherein the member profile information satisfying some predefined criteria includes member profile information indicating that a member having member profile information indicating current employment with the target entity has a seniority level that meets or exceeds some predefined seniority level.

5. The method of claim 1, wherein the member profile information satisfying some predefined criteria is member profile information indicating that a member having member profile information indicating current employment with the target entity was previously employed at a company with which the member and target entity pairing was also employed.

6. The method of claim 1, wherein the member profile information satisfying some predefined criteria is member profile information indicating that a member having member profile information indicating current employment with the target entity previously matriculated at, or graduated from, a school at which the member of the member and target entity pairing matriculated, or from which the member of the member and target entity pairing graduated.

7. The method of claim 1, wherein the member profile information satisfying some predefined criteria is member profile information indicating that a member currently employed with the target entity shares in common a predefined number of skills with the member of the member and target entity pairing.

8. The method of claim 1, wherein the member profile information satisfying some predefined criteria is member profile information indicating that a member currently employed with the target entity shares in common with the member of the member and target entity pairing membership in a group or professional organization.

9. The method of claim 1, wherein the member profile information satisfying some predefined criteria is member profile information indicating that a member currently employed with the target entity shares in common with the member of the member and target entity pairing a predefined number and selection of member profile attributes.

10. The method of claim 1, further comprising:
in deriving the social proximity score, applying separate weighting factors to the first and second-degree connections that the member has to other members of the social networking service who i) have member profile information indicating current employment with the target entity and ii) share in common with the first member a predefined number of connections with other members of the social networking service.

11. The method of claim 1, further comprising:
normalizing each social proximity score by dividing the number of connections that the first member has to other members of the social networking service who have member profile information indicating current employment with the target entity and where the connections satisfy some predefined criteria with the number of members of the social network service who have member profile information indicating current employment with the target entity and where the connections satisfy the same predefined criteria.

12. The method of claim 1, wherein the predefined criteria is user-customizable.

13. A non-transitory computer readable storage medium storing instructions thereon, which, when executed by one or more processors of one or more computers, cause the one or more computers to:
receive a request to generate social proximity scores for each member and target entity pairing for a set of members of a social networking service and a set of target entities;
for each member and target entity pairing, derive a social proximity score as a weighted combination of the number of first-degree and the number of second-degree connections that the member has with other members of the social networking service who have member profile information indicating current employment with the target entity and ii) satisfying some predefined criteria; and
store the social proximity scores for each member and target entity pairing.

14. The non-transitory computer readable storage medium of claim 13, wherein the member profile information satisfying some predefined criteria includes member profile information indicating that a member having member profile information indicating current employment with the target entity has a job title matching any one of a plurality of predefined job titles.

15. The non-transitory computer readable storage medium of claim 13, wherein the member profile information satisfying some predefined criteria includes member profile information indicating that a member having member profile information indicating current employment with the target entity has a job function matching any one of a plurality of predefined job functions.

16. The non-transitory computer readable storage medium of claim 13, wherein the member profile information satisfying some predefined criteria includes member profile information indicating that a member having member profile information indicating current employment with the target entity has a seniority level that meets or exceeds some predefined seniority level.

17. The non-transitory computer readable storage medium of claim 13, wherein the member profile information satisfying some predefined criteria is member profile information indicating that a member having member profile information indicating current employment with the target entity was previously employed at a company with which the member and target entity pairing was also employed.

18. The non-transitory computer readable storage medium of claim 13, wherein the member profile information satisfying some predefined criteria is member profile information indicating that a member having member profile information indicating current employment with the target entity previously matriculated at, or graduated from, a school at which the member of the member and target entity pairing matriculated, or from which the member of the member and target entity pairing graduated.

19. The non-transitory computer readable storage medium of claim 13, wherein the member profile information satisfying some predefined criteria is member profile information indicating that a member currently employed with the target entity shares in common a predefined number of skills with the member of the member and target entity pairing.

20. The non-transitory computer readable storage medium of claim 13, wherein the member profile information satisfying some predefined criteria is member profile information indicating that a member currently employed with the target entity shares in common with the member of the member and target entity pairing membership in a group or professional organization.

21. The non-transitory computer readable storage medium of claim 13, wherein the member profile information satisfying some predefined criteria is member profile information indicating that a member currently employed with the target entity shares in common with the member of the member and target entity pairing a predefined number and selection of member profile attributes.

22. The non-transitory computer readable storage medium of claim 13, wherein the instructions cause the one or more computers to:
in deriving the social proximity score, apply separate weighting factors to the first and second-degree connections that the member has to other members of the social networking service who i) have member profile information indicating current employment with the target entity and ii) share in common with the first member a predefined number of connections with other members of the social networking service.

23. The non-transitory computer readable storage medium of claim 13, wherein the instructions cause the one or more computers to:
normalize each social proximity score by dividing the number of connections that the first member has to other members of the social networking service who have member profile information indicating current employment with the target entity and where the connections satisfy some predefined criteria with the number of members of the social network service who have member profile information indicating current employment with the target entity and where the connections satisfy the same predefined criteria.

24. The non-transitory computer readable storage medium of claim 13, wherein the predefined criteria is user-customizable.
